(19) United States
(12) Patent Application Publication
(10) Pub. No.: US 2023/0284684 A1
(43) Pub. Date: Sep. 14, 2023

(54) ELECTRONIC ATOMIZATION HEATING BATTERY ASSEMBLY AND ELECTRONIC ATOMIZATION HEATING DEVICE WITH REUSABLE COMPONENT

(71) Applicant: LUXSHARE PRECISION INDUSTRY CO., LTD., Shenzhen City (CN)

(72) Inventors: Huabing LI, Shenzhen City (CN); Zhongyuan LAI, Shenzhen City (CN); Yu HUANG, Shenzhen City (CN)

(73) Assignee: LUXSHARE PRECISION INDUSTRY CO., LTD., Shenzhen City (CN)

(21) Appl. No.: 17/944,305

(22) Filed: Sep. 14, 2022

(30) Foreign Application Priority Data
Mar. 8, 2022 (CN) 202210227207.7

(51) Int. Cl. A24F 40/40; A24F 40/50; A24F 40/10

(52) U.S. Cl. CPC A24F 40/40; A24F 40/50; A24F 40/10

(57) ABSTRACT

An electronic atomization heating battery assembly includes a first housing, a battery accommodating housing, a battery, a battery management module, a control module and a connecting member. The first housing has a first receiving space. The battery accommodating housing is received in the first receiving space. The battery accommodating housing has an accommodating space. The battery is detachably received in the accommodating space. The battery management module is located at one end of the battery. The control module is located at another end of the battery. The battery management module and the control module are detachably connected to the connecting member, so that components such as the battery can be reused. The present disclosure also discloses an electronic atomization heating device having the electronic atomization heating battery assembly.

### CROSS-REFERENCE TO RELATED APPLICATION

This patent application claims priority of a Chinese Patent Application No. 202210227207.7, filed on Mar. 8, 2022 and titled “ELECTRONIC ATOMIZATION HEATING BATTERY ASSEMBLY AND ELECTRONIC ATOMIZATION HEATING DEVICE”, the entire content of which is incorporated herein by reference.

### TECHNICAL FIELD

The present disclosure relates to an electronic atomization heating battery assembly and an electronic atomization heating device, which belongs to a technical field of electronic atomization heating.

### BACKGROUND

The electronic atomization heating device (e.g., an electronic cigarette) in the related art includes a battery, a battery management module, a control module, an e-liquid tank housing, a heating element, and the like. The battery, the battery management module and the control module are assembled into a whole by welding or other means, which results in that some components cannot be reused, the cost is high, and the environmental protection is poor.

### SUMMARY

An object of the present disclosure is to provide an electronic atomization heating battery assembly and an electronic atomization heating device which are easy to disassemble and can realize battery reuse.

In order to achieve the above object, the present disclosure adopts the following technical solution: an electronic atomization heating battery assembly, including: a first housing having a first receiving space; a battery accommodating housing received in the first receiving space, the battery accommodating housing being provided with an accommodating space; a battery detachably received in the accommodating space of the battery accommodating housing; a battery management module located at one end of the battery; a control module located at another end of the battery; and a connecting member, the battery management module and the control module being detachably connected to the connecting member.

In order to achieve the above object, the present disclosure adopts the following technical solution: an electronic atomization heating device, including: the electronic atomization heating battery assembly; and an electronic atomization heating e-liquid storage assembly, including: a second housing having a second receiving space; an e-liquid tank housing received in the second receiving space; an e-liquid storage element received in the e-liquid tank housing; an e-liquid guiding element adapted to adsorb e-liquid from the e-liquid storage element; and a heating element including a heating portion, the heating portion being adapted to heat the e-liquid adsorbed in the e-liquid guiding element into a gaseous state; wherein the electronic atomization heating battery assembly and the electronic atomization heating e-liquid storage assembly are mated with each other.

Compared with the prior art, the present disclosure can realize the reuse of components, such as the battery, by detachably connecting the battery management module and the control module with the connecting member.

### BRIEF DESCRIPTION OF DRAWINGS

FIG. 1 is a schematic perspective view of an electronic atomization heating device in accordance with an embodiment of the present disclosure;

FIG. 2 is a perspective schematic view of FIG. 1 from another angle;

FIG. 3 is a partially exploded perspective view of FIG. 1, wherein an electronic atomization heating battery assembly and an electronic atomization heating e-liquid storage assembly are separated from each other;

FIG. 4 is the partial perspective exploded view of FIG. 3 from another angle;

FIG. 5 is a partial perspective exploded view of the electronic atomization heating battery assembly in FIG. 4, wherein a first housing is separated;

FIG. 6 is a partial perspective exploded view of FIG. 5 from another angle;

FIG. 7 is a partially exploded perspective view after removing a battery accommodating housing in FIG. 5;

FIG. 8 is a partially exploded perspective view of FIG. 7 from another angle;

FIG. 9 is a partially exploded perspective view of a battery fixing and sealing cover, the battery accommodating housing and an anti-loosening member in FIG. 7;

FIG. 10 is a partial perspective exploded view of FIG. 9 from another angle;

FIG. 11 is an exploded perspective view of the electronic atomization heating battery assembly in accordance with the embodiment of the present disclosure;

FIG. 12 is a perspective exploded view of FIG. 11 from another angle;

FIG. 13 is a partially exploded perspective view of the electronic atomization heating e-liquid storage assembly in FIG. 4, wherein a second housing is separated;

FIG. 14 is a partially exploded perspective view of FIG. 13 from another angle;

FIG. 15 is a partially exploded perspective view after removing the second housing in FIG. 13;

FIG. 16 is a partially exploded perspective view of FIG. 15 from another angle;

FIG. 17 is a further partial perspective exploded view of FIG. 15;

FIG. 18 is a partially exploded perspective view of FIG. 17 from another angle;

FIG. 19 is an exploded perspective view of a first contact terminal, a second contact terminal, a heating element, an e-liquid absorbing element and a clamping pipe in FIG. 17;

FIG. 20 is a perspective exploded view of FIG. 19 from another angle;

FIG. 21 is a perspective exploded view of the electronic atomization heating e-liquid storage assembly in FIG. 4;

FIG. 22 is a perspective exploded view of FIG. 21 from another angle;

FIG. 23 is a schematic cross-sectional view taken along line A-A in FIG. 3;

FIG. 24 is a schematic cross-sectional view taken along line B-B in FIG. 4;

FIG. 25 is a schematic cross-sectional view taken along line C-C in FIGS. 1; and

FIG. 26 is a partial enlarged view of a frame portion D in FIG. 25.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

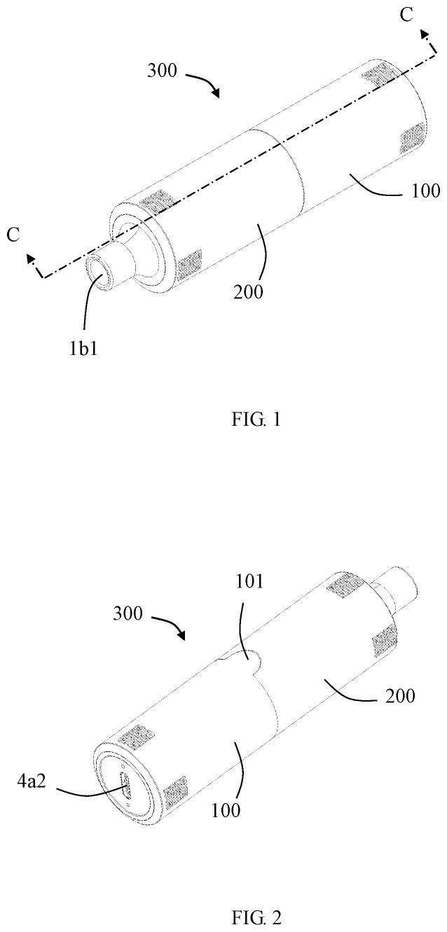

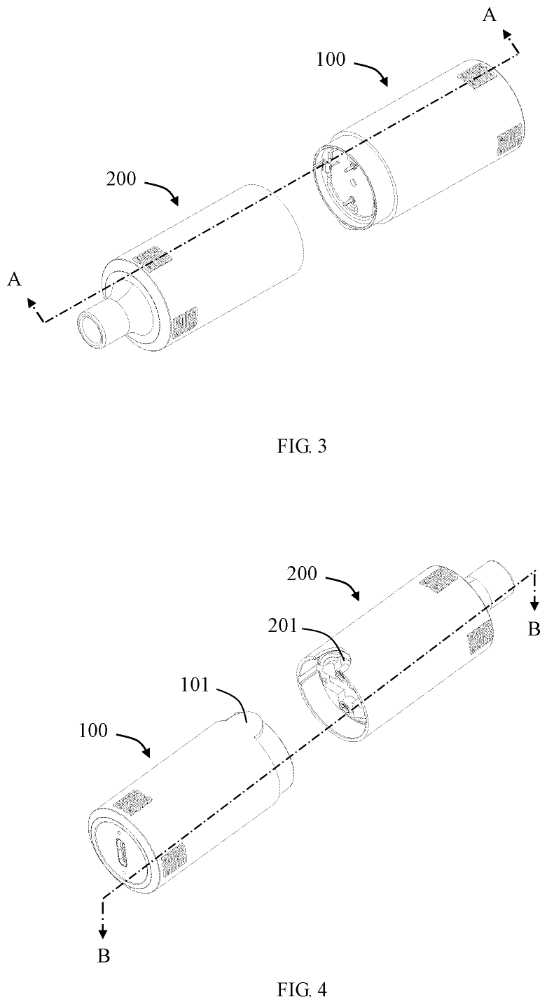

Referring to FIGS. 1 to 4, the present disclosure discloses an electronic atomization heating device 300 which includes an electronic atomization heating battery assembly 100 and an electronic atomization heating e-liquid storage assembly 200. The electronic atomization heating battery assembly 100 and the electronic atomization heating e-liquid storage assembly 200 are connected to each other. In an embodiment of the present disclosure, one of the electronic atomization heating battery assembly 100 and the electronic atomization heating e-liquid storage assembly 200 is provided with an engaging protrusion 101, and a remaining one of the electronic atomization heating battery assembly 100 and the electronic atomization heating e-liquid storage assembly 200 is provided with an engaging recess 201. The precise assembly of the electronic atomization heating battery assembly 100 and the electronic atomization heating e-liquid storage assembly 200 is achieved through the mating of the engaging protrusion 101 and the engaging recess 201.

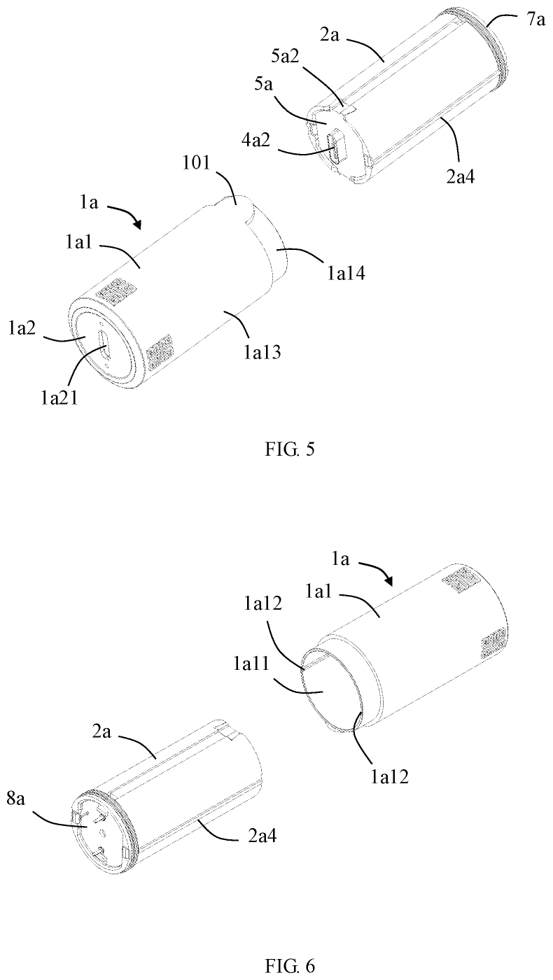

Referring to FIGS. 5 to 12, in the embodiment shown in the present disclosure, the electronic atomization heating battery assembly 100 includes a first housing 1a, a battery accommodating housing 2a detachably received in the first housing 1a, a battery 3a detachably received in the battery accommodating housing 2a, a battery management module 4a detachably installed on one end (e.g., a bottom end) of the battery 3a, a battery fixing and sealing cover 5a detachably fixing one end (e.g., the bottom end) of the battery 3a in the battery accommodating housing 2a, an elastic gasket 6a detachably mounted on another end (e.g., a top end) of the battery 3a, an anti-loosening member 7a located at one end (e.g., the top end) of the battery accommodating housing 2a, a control module 8a detachably mounted on another end (e.g., a top end) of the battery accommodating housing 2a, and a connecting member 9a electrically connecting the battery management module 4a and the control module 8a. The control module 8a may be an MCU (Microcontroller Unit) control module.

Referring to FIG. 5 and FIG. 6, in the embodiment shown in the present disclosure, the first housing 1a includes a cylindrical first circumferential wall 1a1 and a first bottom wall 1a2 located at the bottom of the first circumferential wall 1a1. The first circumferential wall 1a1 is enclosed to form a first receiving space 1 all for receiving the battery accommodating housing 2a. The first receiving space Tall is of a substantially cylindrical configuration and opens upwardly. An inner side of the first circumferential wall 1a1 further defines a plurality of positioning grooves 1a12. In the illustrated embodiment of the present disclosure, each positioning groove 1a12 extends along an axial direction of the first circumferential wall 1a1.

Preferably, the plurality of positioning grooves 1a12 are evenly distributed along a circumferential direction of the first circumferential wall 1a1. The first bottom wall 1a2 includes a first slot 1a21 which communicates with the first receiving space 1a11 and extends downwardly through the first bottom wall 1a2.

In the embodiment shown in the present disclosure, the first circumferential wall 1a1 includes a first main body portion 1a13, and a first constricted portion 1a14 connected to the first main body portion 1a13 and located at the top of the first main body portion 1a13. An outer diameter of the first constricted portion 1a14 is smaller than an outer diameter of the first main body portion 1a13 so as to form a step. The first constricted portion 1a14 is adapted for being inserted into the electronic atomization heating e-liquid storage assembly 200. The engaging protrusion 101 is connected to the first main body portion 1a13. The engaging protrusion 101 protrudes to an outer surface of the first constricted portion 1a14 along the axial direction of the first circumferential wall 1a1.

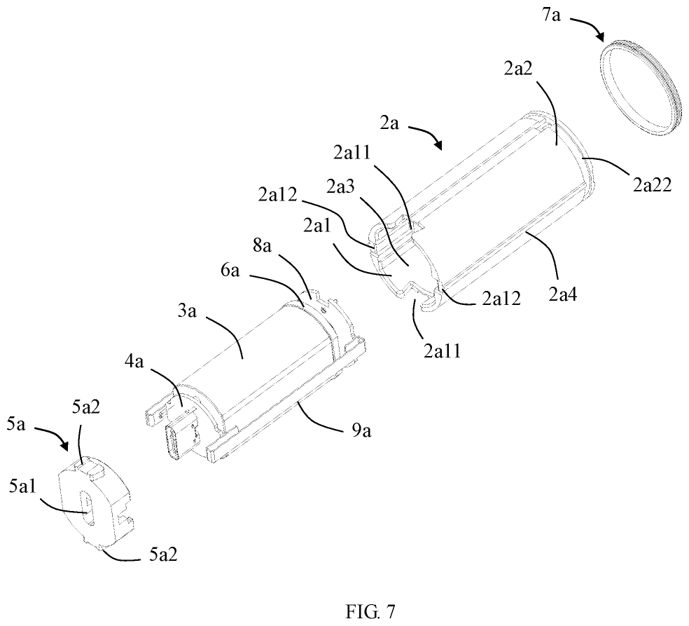

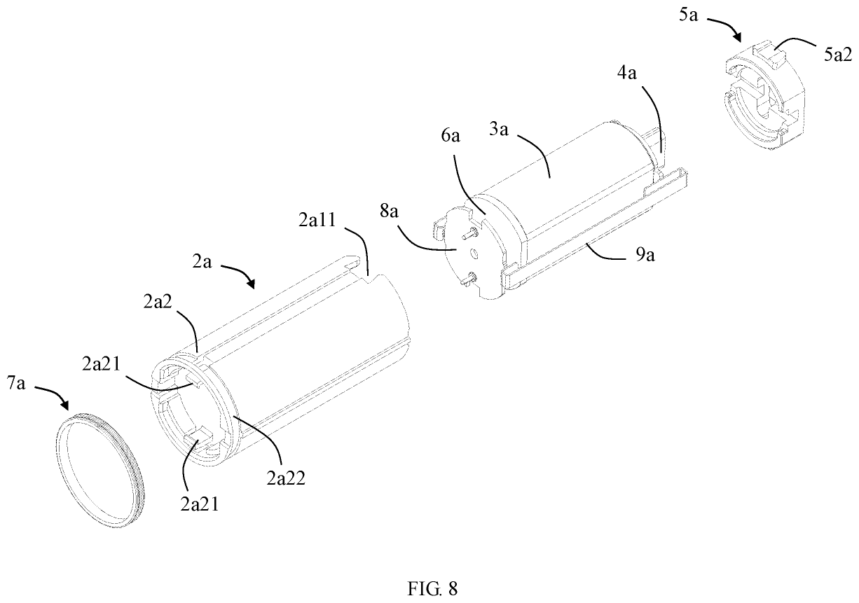

Referring to FIG. 7 and FIG. 8, the battery accommodating housing 2a is also of a substantially cylindrical configuration. The battery accommodating housing 2a includes a first end portion 2a1, a second end portion 2a2 opposite to the first end portion 2a1, and an accommodating space 2a3 for accommodating the battery 3a. In the embodiment shown in the present disclosure, the first end portion 2a1 is a lower end portion, and the second end portion 2a2 is an upper end portion. An outer surface of the battery accommodating housing 2a is provided with a plurality of positioning ribs 2a4. Each positioning rib 2a4 extends along the axial direction. The positioning ribs 2a4 are used to be inserted into corresponding positioning grooves 1a12 along the axial direction. The first end portion 2a1 is further provided with a pair of first recesses 2a11 recessed toward the second end portion 2a2 and a pair of second recesses 2a12 recessed toward the second end portion 2a2. The pair of first recesses 2a11 are distributed along a first direction (e.g., a top-bottom direction). The pair of second recesses 2a12 are distributed along a second direction (e.g., a left-right direction). The second end portion 2a2 is provided with an elastic locking arm 2a21 located on an inner side of the battery accommodating housing 2a. The elastic locking arm 2a21 includes a hook portion protruding inwardly into the accommodating space 2a3. In the embodiment of the present disclosure, at least two elastic locking arms 2a21 are provided, and they are evenly distributed on the inner side of the battery accommodating housing 2a. In addition, an outer surface of the second end portion 2a2 is further provided with an annular groove 2a22. The annular groove 2a22 is adapted to receive the anti-loosing member 7a. In an embodiment of the present disclosure, the anti-loosing member 7a may be soft glue. In other embodiments of the present disclosure, the anti-loosing member 7a may also be a sealing ring or the like.

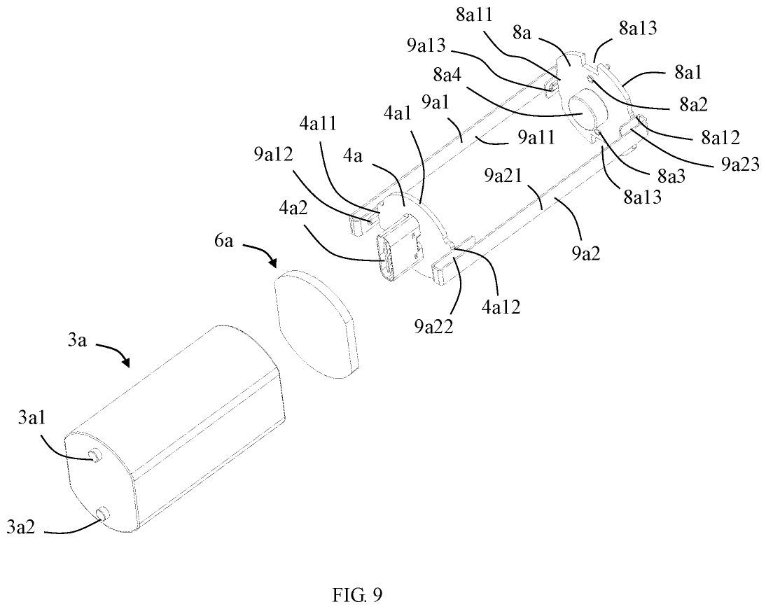

Referring to FIG. 9, the battery 3a includes a first pole 3a1 and a second pole 3a2 which are located at one end (e.g., the bottom end) of the battery 3a, wherein one of the first pole 3a1 and the second pole 3a2 is a positive electrode, and a remaining one of the first pole 3a1 and the second pole 3a2 is a negative electrode.

Referring to FIGS. 9 to 12, the battery management module 4a includes a first circuit board 4a1 and an electrical connector 4a2 mounted to the first circuit board 4a1. The first circuit board 4a1 includes a first contact element 4a11 and a second contact element 4a12. The electrical connector 4a2 is electrically connected to the first circuit board 4a1. The electrical connector 4a2 serves as a charging port of the electronic atomization heating battery assembly 100. In the embodiment shown in the present disclosure, the electrical connector 4a2 is a USB Type C connector. The first pole 3a1 and the second pole 3a2 of the battery 3a are in abutment with the first circuit board 4a1 for electrical connection. In the embodiment shown in the present disclosure, the first contact element 4a11 and the second contact element 4a12 are both conductive pads. The first contact element 4a11 and the second contact element 4a12 are disposed opposite to each other and protrude laterally from edges of the first circuit board 4a1, respectively. In the embodiment shown in the present disclosure, the first contact element 4a11 and the second contact element 4a12 are received in the pair of second recesses 2a12 for positioning.

Referring to FIGS. 5, 7 and 8, the battery fixing and sealing cover 5a is at least partially received in the accommodating space 2a3 so that the battery fixing and sealing cover 5a is assembled and fixed to the first end portion 2a1 of the battery accommodating housing 2a. The battery fixing and sealing cover 5a includes a through hole 5a1 for allowing the electrical connector 4a2 to pass through and protruding portions 5a2 protruding from edges of the battery fixing and sealing cover 5a in the top-bottom direction, respectively. The protruding portions 5a2 are received in the pair of first recesses 2a11 for positioning. In the illustrated embodiment of the present disclosure, at least two protruding portions 5a2 are provided, and they are evenly spaced and arranged on an edge of the battery fixing and sealing cover 5a. Both the protruding portions 5a2 and the first recesses 2a11 are wedge-shaped, so that when the protruding portions 5a2 are assembled into the first recesses 2a11 through deformation, the battery fixing and sealing cover 5a can be prevented from falling off from the battery accommodating housing 2a.

The elastic gasket 6a is made of non-conductive elastic EVA or soft glue. The elastic gasket 6a is in abutment with another end of the battery 3a. Another end of the battery 3a is an end of the battery 3a opposite to the first pole 3a1 and the second pole 3a2. The elastic gasket 6a can provide a certain buffer to the battery 3a.

Referring to FIGS. 8 to 12, the control module 8a includes a second circuit board 8a1, a first mating terminal 8a2 and a second mating terminal 8a3 which are electrically connected to the second circuit board 8a1, and an airflow sensing/power control integrated element 8a4. The airflow sensing/power control integrated element 8a4 is fixed to the second circuit board 8a1 and abuts against the elastic gasket 6a. The second circuit board 8a1 is provided with an escape slot 8a13 corresponding to the elastic locking arm 2a21 of the battery accommodating housing 2a. After the second circuit board 8a1 is assembled in place, the elastic locking arm 2a21 passes through the corresponding escape slot 8a13, so that the hook portion of the elastic locking arm 2a21 is locked with the second circuit board 8a1. In the embodiment of the present disclosure, the elastic locking arms 2a21 and the escape slots 8a13 have the same number and one-to-one correspondence. Both the elastic locking arms 2a21 and the escape slots 8a13 are evenly spaced apart, so that the force can be evenly applied to prevent loosening. The second circuit board 8a1 includes a third contact element 8a11 and a fourth contact element 8a12. In the embodiment shown in the present disclosure, the third contact element 8a11 and the fourth contact element 8a12 are both conductive pads. The third contact element 8a11 and the fourth contact element 8a12 are disposed opposite to each other, and protrude laterally from edges of the second circuit board 8a1, respectively.

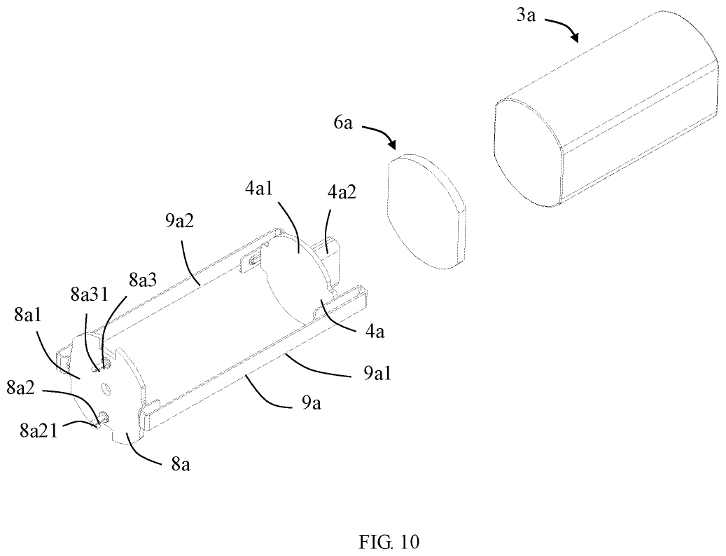

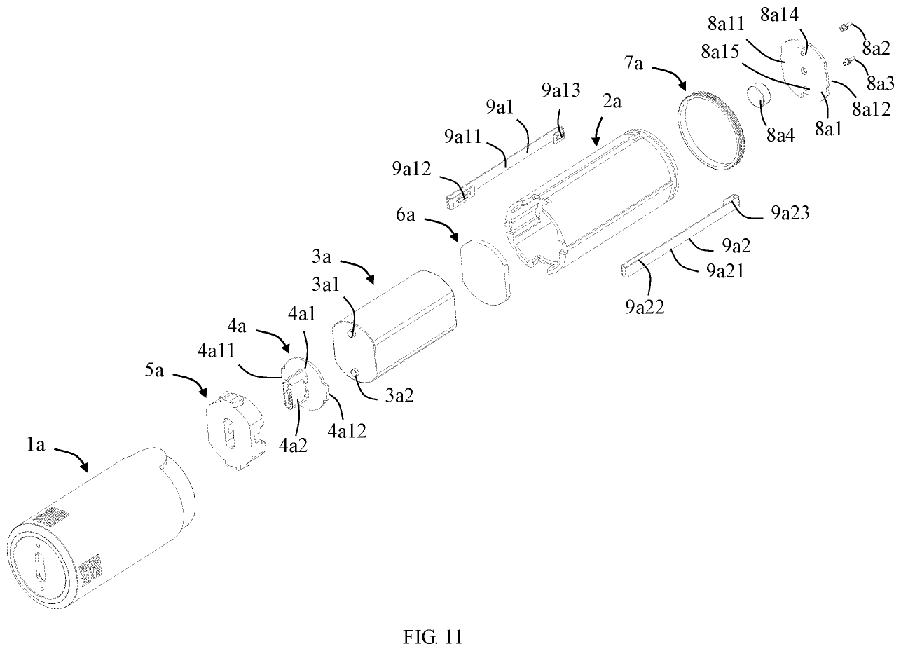

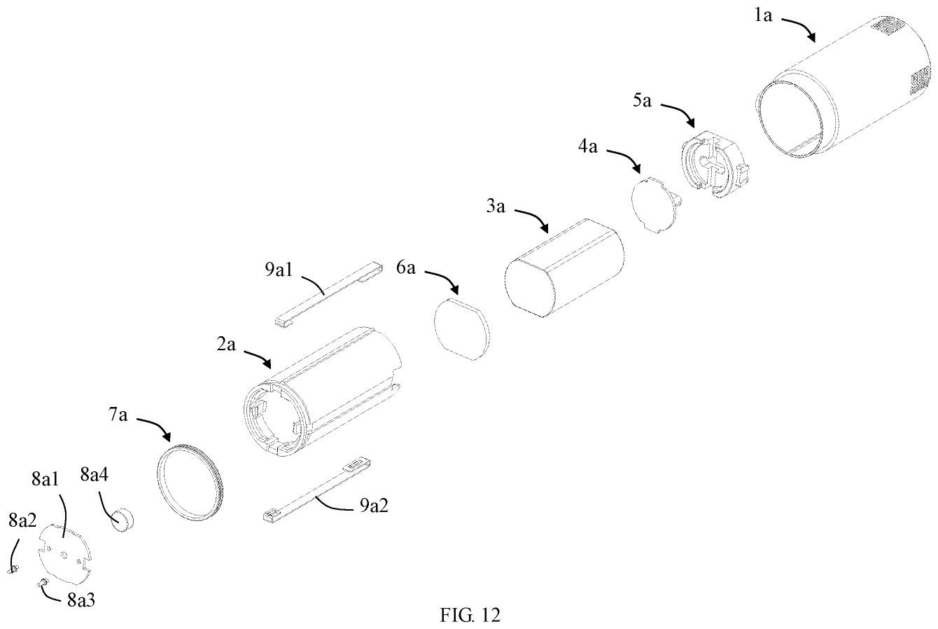

In the embodiment shown in the present disclosure, the first mating terminal 8a2 and the second mating terminal 8a3 are directly assembled and fixed to the second circuit board 8a1. Specifically, referring to FIG. 11, the second circuit board 8a1 includes a first hole 8a14 into which the first mating terminal 8a2 is inserted, and a second hole 8a15 into which the second mating terminal 8a3 is inserted. Referring to FIG. 10, the first mating terminal 8a2 and the second mating terminal 8a3 protrude beyond the second circuit board 8a1 along the axial direction toward the electronic atomization heating e-liquid storage assembly 200. Specifically, the first mating terminal 8a2 includes a first plug portion 8a21 protruding beyond the second circuit board 8a1. The first plug portion 8a21 is substantially cylindrical. The second mating terminal 8a3 includes a second plug portion 8a31 protruding beyond the second circuit board 8a1. The second plug portion 8a31 is substantially cylindrical. The first plug portion 8a21 and the second plug portion 8a31 are parallel to each other, and both extend along the axial direction.

Referring to FIGS. 7 to 12, the connecting member 9a includes a first connecting member 9a1 and a second connecting member 9a2. The first connecting member 9a1 connects the first contact element 4a11 of the first circuit board 4a1 and the third contact element 8a11 of the second circuit board 8a1. The second connecting member 9a2 connects the second contact element 4a12 of the first circuit board 4a1 and the fourth contact element 8a12 of the second circuit board 8a1. In this way, the first circuit board 4a1 and the second circuit board 8a1 can be electrically connected. Since the first circuit board 4a1 is connected to the battery 3a, the second circuit board 8a1 is also connected to the battery 3a. That is, the management in the state of charge of the battery 3a can be realized by the first circuit board 4a1. The battery 3a can transmit electric power to the first mating terminal 8a2 in a discharged state, by electrically connecting the first circuit board 4a1 and the second circuit board 8a1 through the first connecting member 9a1 and the second connecting member 9a2.

The first connecting member 9a1 and the second connecting member 9a2 are secured in the battery accommodating housing 2a. In the embodiment shown in the present disclosure, the first connecting member 9a1 and the second connecting member 9a2 are insert-molded in the battery accommodating housing 2a. Of course, in other embodiments, the first connecting member 9a1 and the second connecting member 9a2 may also be assembled to the battery accommodating housing 2a. In the embodiment illustrated in the present disclosure, the first connecting member 9a1 and the second connecting member 9a2 are both metal pieces. Two ends of the first connecting piece 9a1 and two ends of the second connecting piece 9a2 are U-shaped, so that the two ends of the first connecting piece 9a1 and the two ends of the second connecting piece 9a2 have certain elasticity, thereby improving the reliability when contacting the first circuit board 4a1 and the second circuit board 8a1. In the embodiment shown in the present disclosure, the first connecting member 9a1 and the second connecting member 9a2 do not need to be soldered with the first circuit board 4a1 and the second circuit board 8a1, thereby improving the detachability.

Specifically, the first connecting member 9a1 includes a first body portion 9a11, a first bent portion 9a12 bent inwardly and backwardly from one end (e.g., a bottom end) of the first body portion 9a11, and a third bent portion 9a13 bent inwardly and backwardly from another end (e.g., a top end) of the first body portion 9a11. The first bent portion 9a12 and the third bent portion 9a13 are closer to the first circuit board 4a1, so that the reliability of contact is high and the structure is relatively compact. The first bent portion 9a12 and the third bent portion 9a13 are both parallel to the first body portion 9a11. The first body portion 9a11 is insert-molded in the battery accommodating housing 2a. Both the first bent portion 9a12 and the third bent portion 9a13 are exposed in the accommodating space 2a3. Of course, in other embodiments, the first body portion 9a11 can also be embedded or inserted in the battery accommodating housing 2a, so that the first body portion 9a11 can also be fixed to the battery accommodating housing 2a.

Similarly, the second connecting member 9a2 includes a second body portion 9a21, a second bent portion 9a22 bent inwardly and backwardly from one end (e.g., a bottom end) of the second body portion 9a21, and a fourth bent portion 9a23 bent inwardly and backwardly from another end (e.g., a top end) of the second body portion 9a21. The second bent portion 9a22 and the fourth bent portion 9a23 are closer to the second circuit board 8a1, so that the reliability of contact is high and the structure is relatively compact. The second bent portion 9a22 and the fourth bent portion 9a23 are both parallel to the second body portion 9a21. The second body portion 9a21 is insert-molded in the battery accommodating housing 2a. Both the second bent portion 9a22 and the fourth bent portion 9a23 are exposed in the accommodating space 2a3. Of course, in other embodiments, the second body portion 9a21 can also be embedded or inserted in the battery accommodating housing 2a, so that the second body portion 9a21 can also be fixed to the battery accommodating housing 2a.

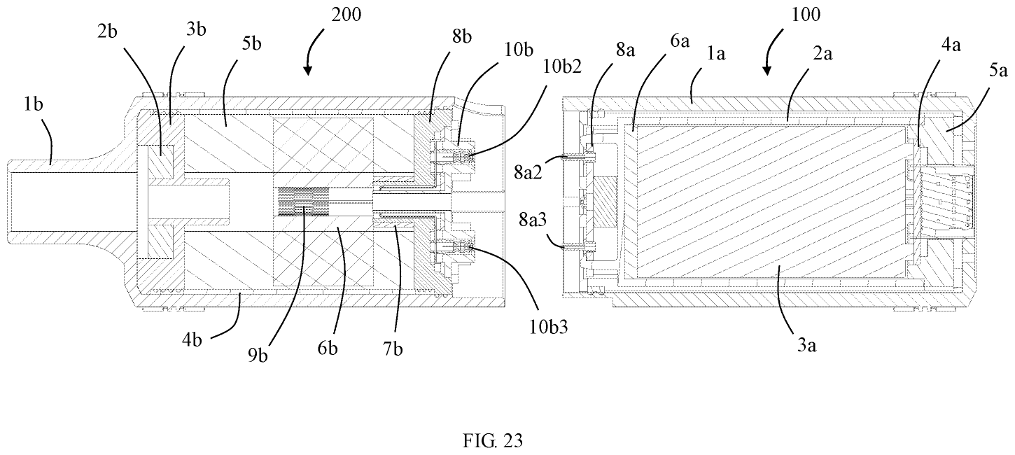

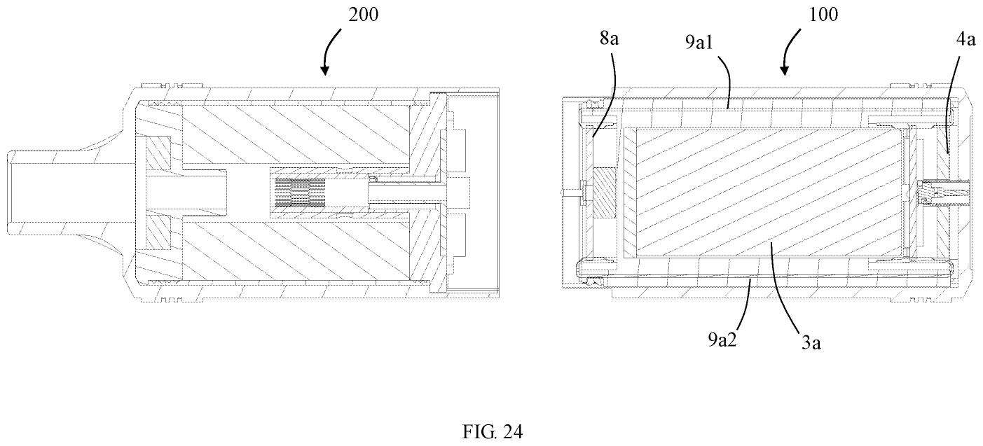

Referring to FIGS. 7 to 12, FIG. 23 and FIG. 24, after the first circuit board 4a1 and the second circuit board 8a1 are assembled in place, the first bent portion 9a12 is in abutment with the first contact element 4a11, the third bent portion 9a13 is in abutment with the third contact element 8a11, the second bent portion 9a22 is in abutment with the second contact element 4a12, and the fourth bent portion 9a23 is in abutment with the fourth contact element 8a12. In the embodiment shown in the present disclosure, the first bent portion 9a12, the second bent portion 9a22, the third bent portion 9a13 and the fourth bent portion 9a23 are provided with ribs in abutment with the first contact element 4a11, the second contact element 4a12, the third contact element 8a11 and the fourth contact element 8a12, so as to improve the contact reliability.

In an embodiment of the present disclosure, when assembling the electronic atomization heating battery assembly 100, the first mating terminal 8a2 and the second mating terminal 8a3 are assembled with the second circuit board 8a1. The airflow sensing/power control integrated element 8a4 is fixed to the second circuit board 8a1. The control module 8a is assembled to the second end portion 2a2 of the battery accommodating housing 2a. The anti-loosing member 7a is disposed in the annular groove 2a22. The first connecting member 9a1 and the second connecting member 9a2 are fixed to the battery accommodating housing 2a. The elastic gasket 6a is inserted into the accommodating space 2a3 from the first end 2a1 of the battery accommodating housing 2a. The battery 3a is installed into the accommodating space 2a3 from the first end 2a1 of the battery accommodating housing 2a. The battery management module 4a is assembled with the battery fixing and sealing cover 5a, so that the electrical connector 4a2 passes through the through hole 5a1 of the battery fixing and sealing cover 5a. The assembled battery management module 4a and the battery fixing and sealing cover 5a are installed into the first end portion 2a1 of the battery accommodating housing 2a. Finally, the assembled integral parts are assembled into the first receiving space 1a11 of the first housing 1a.

Compared with the prior art, the battery 3a of the present disclosure can be reused, thereby reducing environmental pollution.

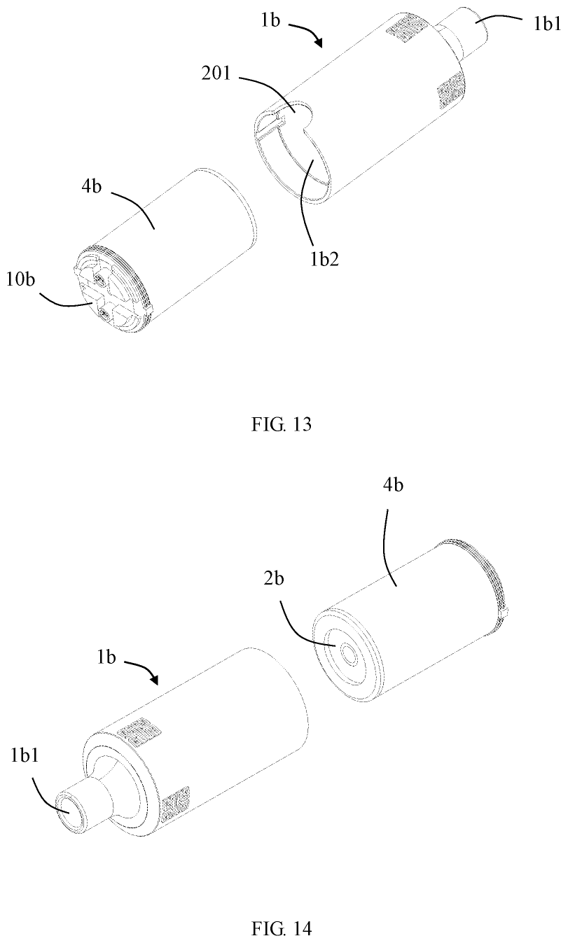

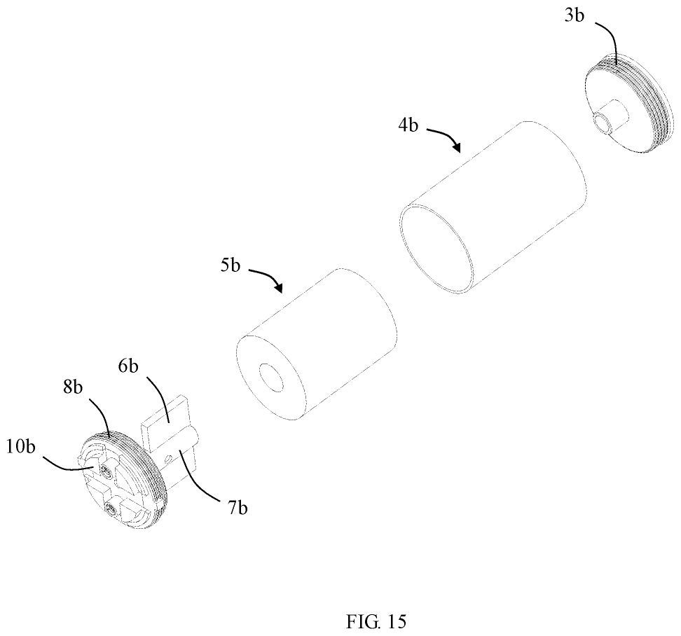

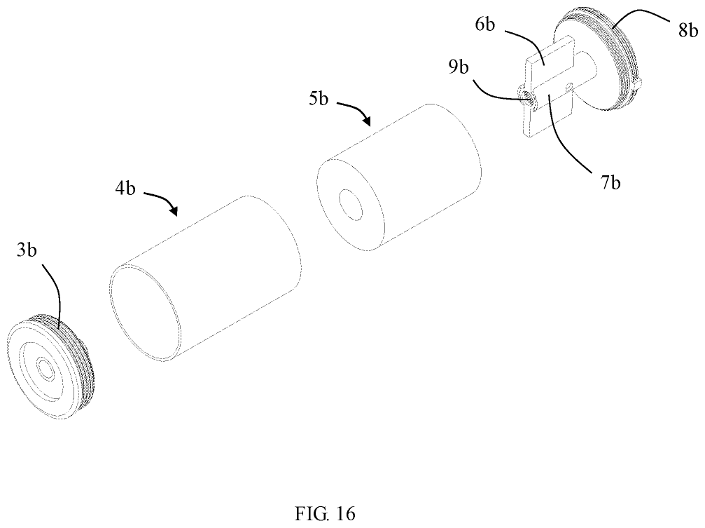

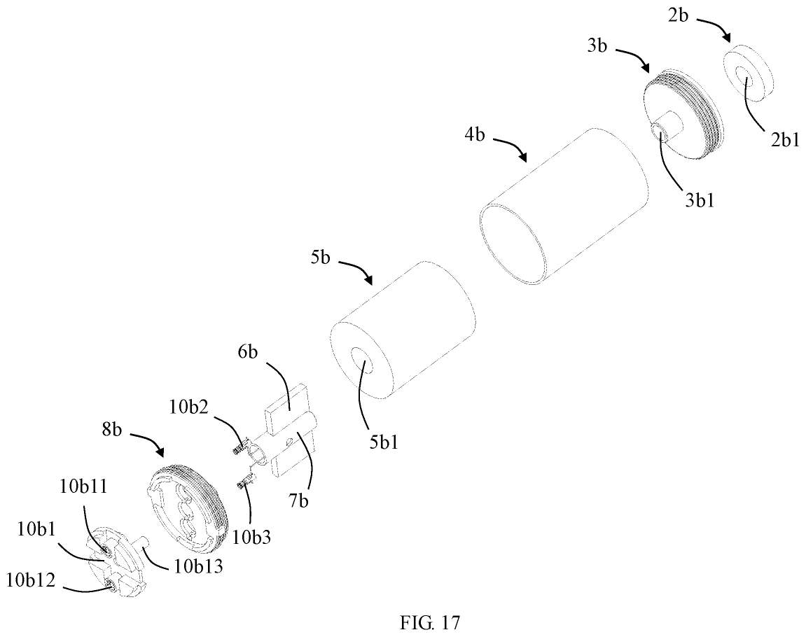

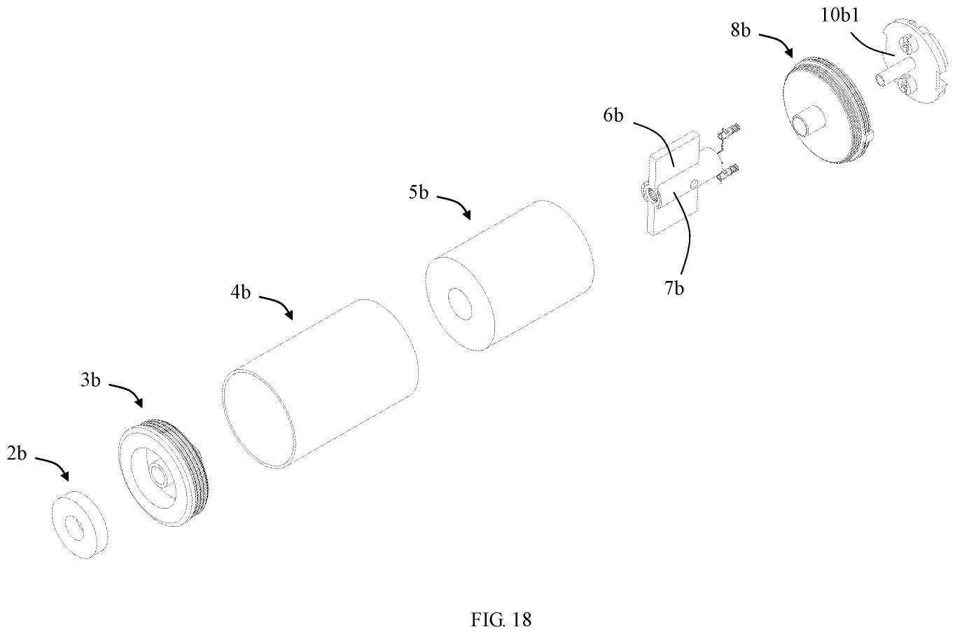

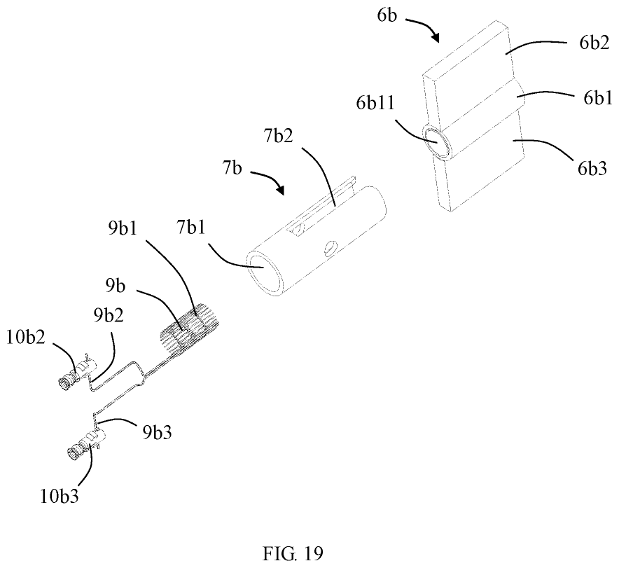

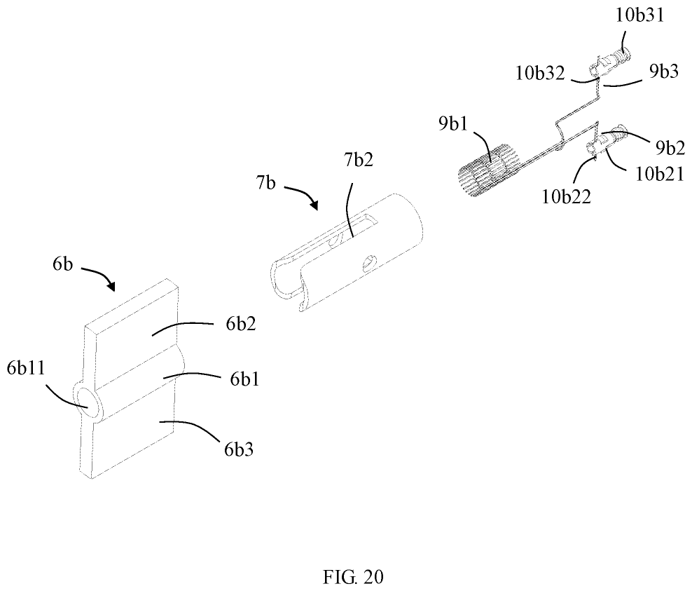

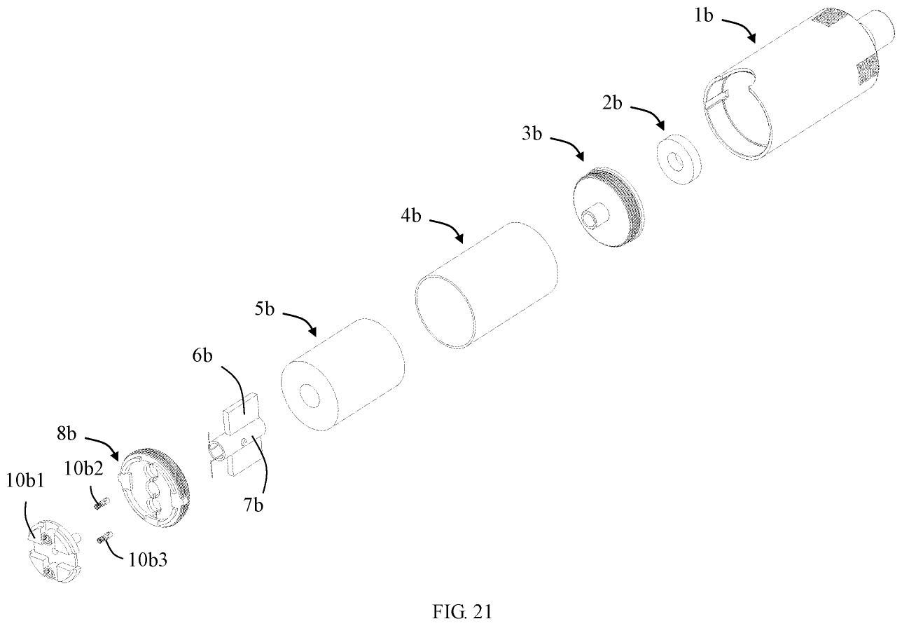

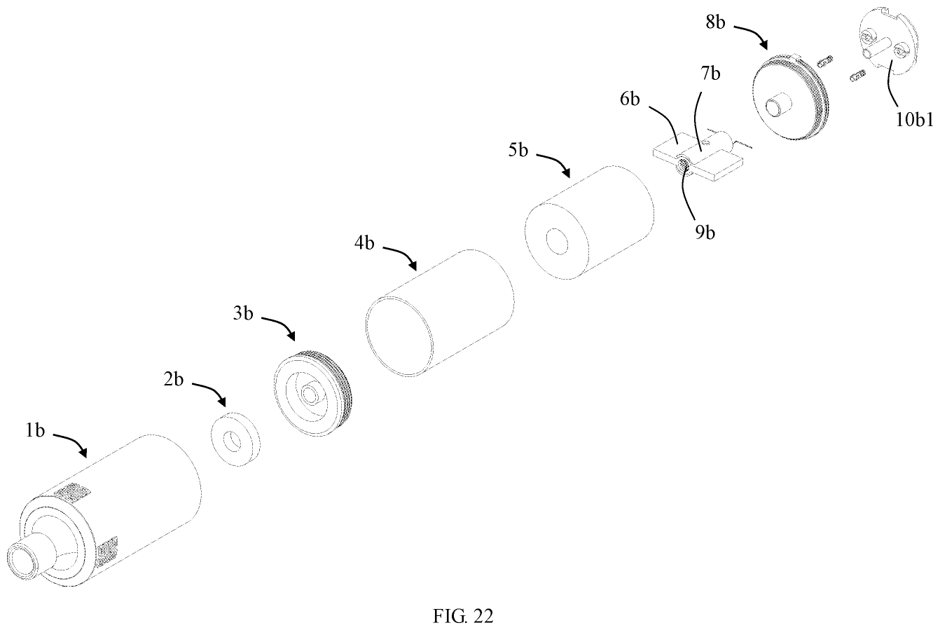

Referring to FIGS. 13 to 22, the electronic atomization heating e-liquid storage assembly 200 includes a second housing 1b, an e-liquid absorbing element 2b, an e-liquid tank upper sealing cover 3b, an e-liquid tank housing 4b, an e-liquid storage element 5b, an e-liquid guiding element 6b, a clamping pipe 7b, an e-liquid tank lower sealing cover 8b, a heating element 9b, and a sealing cover assembly 10b.

Specifically, the second housing 1b includes a mouthpiece 1b1 and a second receiving space 1b2. The engaging recess 201 is formed on the second housing 1b. The e-liquid absorbing element 2b, the e-liquid tank upper sealing cover 3b, the e-liquid tank housing 4b, the e-liquid storage element 5b, the e-liquid guiding element 6b, the clamping pipe 7b, the e-liquid tank lower sealing cover 8b, the heating element 9b, and the sealing cover assembly 10b are all received in the second receiving space 1b2.

In an embodiment of the present disclosure, the e-liquid absorbing element 2b is an e-liquid absorbing cotton. The e-liquid absorbing element 2b is provided with a perforation 2b1 communicating with the mouthpiece 1b1.

In an embodiment of the present disclosure, the e-liquid tank upper sealing cover 3b is a soft rubber sealing cover in order to improve the sealing performance. The e-liquid tank upper sealing cover 3b includes a first channel 3b1 communicating with the perforation 2b1.

In an embodiment of the present disclosure, the e-liquid tank housing 4b is in the shape of a hollow cylinder, and is adapted for refilling e-liquid. The e-liquid tank upper sealing cover 3b is at least partially inserted into the e-liquid tank housing 4b, and is sealed at an upper end of the e-liquid tank housing 4b. The e-liquid tank lower sealing cover 8b is at least partially inserted into the e-liquid tank housing 4b, and is sealed at a lower end of the e-liquid tank housing 4b. It should be noted that it is understandable to those skilled in the art that the terminology “seal” used herein refers to preventing the e-liquid from leaking to other places than an e-liquid channel.

The e-liquid storage element 5b is adapted for storing e-liquid. In an embodiment of the present disclosure, the e-liquid storage element 5b is an e-liquid storage cotton. The e-liquid storage element 5b is received in the e-liquid tank housing 4b. The e-liquid storage element 5b defines a second channel 5b1 communicating with the first channel 3b1 of the e-liquid tank upper sealing cover 3b.

The e-liquid guiding element 6b is in contact with the e-liquid storage element 5b, so as to guide and absorb the e-liquid derived from the e-liquid storage element 5b. In an embodiment of the present disclosure, the e-liquid guiding element 6b is an e-liquid guiding cotton. The e-liquid guiding element 6b includes a pipe body 6b1, a first extension portion 6b2 extending from one side of the pipe body 6b1, and a second extension portion 6b3 extending from another side of the pipe body 6b1. The pipe body 6b1 is provided with a third channel 6b11 communicating with the second channel 5b1. The first extension portion 6b2 and the second extension portion 6b3 are substantially flat.

In an embodiment of the present disclosure, the clamping pipe 7b is a hollow metal pipe. The clamping pipe 7b is provided with an accommodation space 7b1. The clamping pipe 7b is of a substantially cylindrical shape. The pipe body 6b1 of the e-liquid guiding element 6b is received in the accommodation space 7b1. The clamping pipe 7b includes slots 7b2 extending in the axial direction and extending backwardly through an outer wall of the clamping pipe 7b. The first extension portion 6b2 and the second extension portion 6b3 of the e-liquid guiding element 6b are inserted into the slots 7b2 so as to be assembled with the clamping pipe 7b.

In an embodiment of the present disclosure, the e-liquid tank lower sealing cover 8b is a soft rubber sealing cover in order to improve the sealing performance. Preferably, the e-liquid tank lower sealing cover 8b is inserted into the e-liquid tank housing 4b by means of elastic extrusion. In this way, on the premise of not affecting the fixing effect, the e-liquid can be prevented from leaking to the outside as much as possible, and the convenience of assembly and disassembly is also improved.

In an embodiment of the present disclosure, the heating element 9b is a heating wire. The heating element 9b includes a heating portion 9b1, a first connecting wire 9b2 connected to the heating portion 9b1, and a second connecting wire 9b3 connected to the heating portion 9b1. The heating portion 9b1 is received in the accommodation space 7b1 of the clamping pipe 7b and/or the pipe body 6b1 of the e-liquid guiding element 6b. The first connecting wire 9b2 and the second connecting wire 9b3 pass through the e-liquid tank lower sealing cover 8b to extend beyond the e-liquid tank lower sealing cover 8b.

In an embodiment of the present disclosure, the sealing cover assembly 10b includes a sealing cover 10b1, a first contact terminal 10b2 fixed to the sealing cover 10b1, and a second contact terminal 10b3 fixed to the sealing cover 10b1. In the embodiment shown in the present disclosure, the first contact terminal 10b2 and the second contact terminal 10b3 are assembled and fixed in the sealing cover 10b1. In the embodiment shown in the present disclosure, the sealing cover 10b1 includes a first terminal mounting hole 10b11, a second terminal mounting hole 10b12, and a positioning post 10b13 located between the first terminal mounting hole 10b11 and the second terminal mounting hole 10b12. The first contact terminal 10b2 and the second contact terminal 10b3 are inserted into the first terminal mounting hole 10b11 and the second terminal mounting hole 10b12, respectively. The e-liquid tank lower sealing cover 8b is sleeved on the positioning post 10b13, so as to improve the assembly precision.

In the embodiment shown in the present disclosure, the first contact terminal 10b2 and the second contact terminal 10b3 are both of hollow configurations. The first contact terminal 10b2 includes a first receiving portion 10b21 and a first slit 10b22 for holding the first connecting wire 9b2. The first receiving portion 10b21 has elasticity so as to better accommodate the first plug portion 8a21 of the first mating terminal 8a2. In the embodiment shown in the present disclosure, the first receiving portion 10b21 is provided with a plurality of slots extending along the axial direction. The slots extend through the first receiving portion 10b21 in a direction away from the heating element 9b, so that the first receiving portion 10b21 has a certain elasticity.

Similarly, the second contact terminal 10b3 includes a second receiving portion 10b31 and a second slit 10b32 for holding the second connecting wire 9b3. The second receiving portion 10b31 has elasticity, so as to better receive the second plug portion 8a31 of the second mating terminal 8a3. In the embodiment shown in the present disclosure, the second receiving portion 10b31 is provided with a plurality of slots extending along the axial direction. The slots extend through the second accommodating portion 10b31 in a direction away from the heating element 9b, so that the second accommodating portion 10b31 has a certain elasticity. In this way, when the electronic atomization heating battery assembly 100 and the electronic atomization heating e-liquid storage assembly 200 are disassembled and then assembled, the first mating terminal 8a2 and the second mating terminal 8a3 can be reliably contacted with the first contact terminal 10b2 and the second contact terminal 10b3, respectively, thereby ensuring proper electrical function.

In an embodiment of the present disclosure, when the electronic atomization heating e-liquid storage assembly 200 is assembled, the first contact terminal 10b2 and the second contact terminal 10b3 are fixed to the sealing cover 10b1 to form the sealing cover assembly 10b. The first connecting wire 9b2 and the second connecting wire 9b3 of the heating element 9b are clipped into the corresponding first slit 10b22 and the second slit 10b32. The aforementioned assembly is assembled with the e-liquid tank lower sealing cover 8b, so that the heating portion 9b1 passes through the e-liquid tank lower sealing cover 8b. The clamping pipe 7b is sleeved on the heating portion 9b1. The e-liquid guiding element 6b is inserted into the slot 7b2 of the clamping pipe 7b. The aforementioned assembly is assembled with the e-liquid storage element 5b. The aforementioned assembly is integrally assembled into the e-liquid tank housing 4b. The e-liquid tank upper sealing cover 3b is assembled into the e-liquid tank housing 4b. The e-liquid absorbing element 2b is assembled to the e-liquid tank upper sealing cover 3b. Finally, the aforementioned assembly is assembled into the second receiving space 1b2 of the second housing 1b.

When the electronic atomization heating device 300 is in a charging state, the electrical connector 4a2 is connected to a mating connector. The battery 3a can be charged under the control of the first circuit board 4a1.

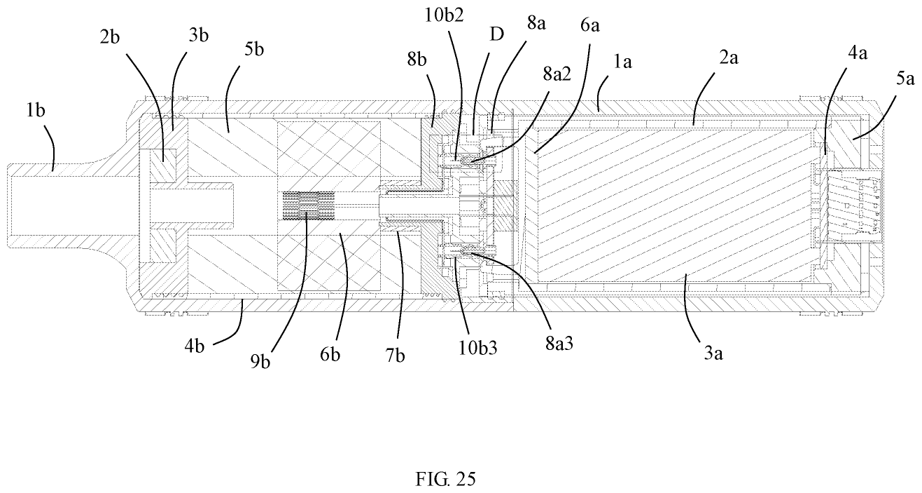

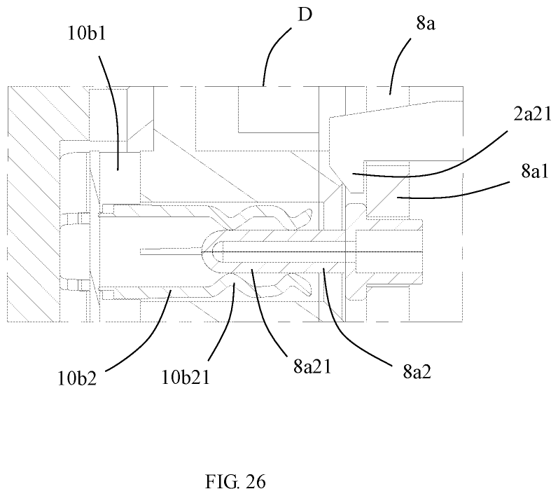

Referring to FIGS. 25 and 26, when the electronic atomization heating device 300 is in use, the battery 3a is connected through the first circuit board 4a1, the first connecting member 9a1, the second connecting member 9a2, the second circuit board 8a1, the first mating terminal 8a2, the second mating terminal 8a3, the first contact terminal 10b2, the second contact terminal 10b3, the first connecting wire 9b2 and the second connecting wire 9b3 so as to provide power to the heating portion 9b1. At this time, the heating portion 9b1 generates heat and heats the e-liquid. The heated e-liquid is in a gaseous state, and passes through the third channel 6b11, the second channel 5b1, the first channel 3b1 and the perforation 2b1 to reach the mouthpiece 1b1. The e-liquid storage element 5b is capable of storing (e.g., absorbing) e-liquid. The e-liquid guiding element 6b is in contact with the e-liquid storage element 5b, so that the e-liquid in the e-liquid storage element 5b is gradually transferred to the e-liquid guiding element 6b, and the e-liquid is heated by the heating portion 9b1. With this arrangement, the e-liquid can be fully heated to be in a gaseous state, which avoids heating all the e-liquid at the same time, thereby improving the heating efficiency.

Compared with the prior art, many components of the present disclosure are assembled in a detachable manner, so these components can be reused, which saves costs and reduces pollution. In addition, these components are assembled along the axial direction, so that automatic assembly can be realized more easily, production efficiency can be improved, and installation errors can be reduced.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electronic atomization heating battery assembly, comprising:
a first housing having a first receiving space;
a battery accommodating housing received in the first receiving space, the battery accommodating housing being provided with an accommodating space;
a battery detachably received in the accommodating space of the battery accommodating housing;
a battery management module located at one end of the battery;
a control module located at another end of the battery; and
a connecting member, the battery management module and the control module being detachably connected to the connecting member.

2. The electronic atomization heating battery assembly according to claim 1, wherein the battery management module comprises a first circuit board, the first circuit board comprises a first contact element and a second contact element;
the control module comprises a second circuit board, the second circuit board comprises a third contact element and a fourth contact element;
the connecting member comprises a first connecting member and a second connecting member, the first connecting member connects the first contact element of the first circuit board and the third contact element of the second circuit board; and the second connecting member connects the second contact element of the first circuit board and the fourth contact element of the second circuit board.

3. The electronic atomization heating battery assembly according to claim 2, wherein the first contact element and the second contact element are both conductive pads; the first contact element and the second contact element are disposed opposite to each other, and protrude laterally beyond edges of the first circuit board, respectively.

4. The electronic atomization heating battery assembly according to claim 2, wherein the third contact element and the fourth contact element are both conductive pads; the third contact element and the fourth contact element are disposed opposite to each other, and protrude laterally beyond edges of the second circuit board, respectively.

5. The electronic atomization heating battery assembly according to claim 2, wherein the first connecting member and the second connecting member are both metal pieces, and two ends of the first connecting member and two ends of the second connecting member are of U-shaped configurations.

6. The electronic atomization heating battery assembly according to claim 5, wherein the first connecting member comprises a first body portion, a first bent portion bent inwardly and backwardly from one end of the first body portion, and a third bent portion bent inwardly and backwardly from another end of the first body portion; the first bent portion and the third bent portion are both parallel to the first body portion; the first body portion is secured in the battery accommodating housing;
the second connecting member comprises a second body portion, a second bent portion bent inwardly and backwardly from one end of the second body portion, and a fourth bent portion bent inwardly and backwardly from another end of the second body portion; the second bent portion and the fourth bent portion are both parallel to the second body portion; the second body portion is secured in the battery accommodating housing;
the first bent portion is in abutment with the first contact element, the third bent portion is in abutment with the third contact element, the second bent portion is in abutment with the second contact element, and the fourth bent portion is in abutment with the fourth contact element.

7. The electronic atomization heating battery assembly according to claim 6, wherein the first bent portion, the second bent portion, the third bent portion and the fourth bent portion are respectively provided with ribs in abutment with the first contact element, the second contact element, the third contact element and the fourth contact element.

8. The electronic atomization heating battery assembly according to claim 2, wherein the battery management module comprises an electrical connector mounted to the first circuit board, and the electrical connector is a charging port of the electronic atomization heating battery assembly.

9. The electronic atomization heating battery assembly according to claim 8, wherein the battery comprises a first pole and a second pole in abutment with the first circuit board; and wherein one of the first pole and the second pole is a positive electrode, and a remaining one of the first pole and the second pole is a negative electrode.

10. The electronic atomization heating battery assembly according to claim 1, further comprising a battery fixing and sealing cover which is at least partially received in the accommodating space.

11. The electronic atomization heating battery assembly according to claim 10, wherein the battery fixing and sealing cover comprises protruding portions respectively protruding beyond edges of the battery fixing and sealing cover in a top-bottom direction, the battery accommodating housing comprises first recesses in communication with the accommodating space, both the protruding portions and the first recesses are of wedge-shaped configurations; when the protruding portions are assembled into the first recesses through deformation, the battery fixing and sealing cover is prevented from falling off from the battery accommodating housing.

12. The electronic atomization heating battery assembly according to claim 2, wherein the control module comprises a first mating terminal and a second mating terminal which are electrically connected to the second circuit board;
the first mating terminal comprises a first plug portion protruding beyond the second circuit board, the first plug portion is of a cylindrical configuration;
the second mating terminal comprises a second plug portion protruding beyond the second circuit board, the second plug portion is of a cylindrical configuration; the first plug portion and the second plug portion are parallel to each other.

13. The electronic atomization heating battery assembly according to claim 12, wherein the second circuit board comprises a first hole into which the first mating terminal is inserted, and a second hole into which the second mating terminal is inserted.

14. The electronic atomization heating battery assembly according to claim 1, wherein the battery accommodating housing is provided with an elastic locking arm exposed in the accommodating space; the second circuit board is provided with an escape slot corresponding to the elastic locking arm; after the second circuit board is assembled in place, the elastic locking arm passes through the escape slot, so that a hook portion of the elastic locking arm is locked with the second circuit board.

15. The electronic atomization heating battery assembly according to claim 1, wherein the first housing comprises a cylindrical first circumferential wall, an inner side of the first circumferential wall is provided with a plurality of positioning grooves communicating with the first receiving space;
a plurality of positioning ribs are provided on an outer surface of the battery accommodating housing, and the positioning ribs are configured to be inserted into corresponding positioning grooves along an axial direction.

16. The electronic atomization heating battery assembly according to claim 6, wherein the first body portion is insert-molded in the battery accommodating housing; and the second body portion is insert-molded in the battery accommodating housing.

17. An electronic atomization heating device, comprising:
an electronic atomization heating battery assembly according to claim 1; and
an electronic atomization heating e-liquid storage assembly, the comprising:
a second housing having a second receiving space;
an e-liquid tank housing received in the second receiving space;
an e-liquid storage element received in the e-liquid tank housing;
an e-liquid guiding element adapted to adsorb e-liquid from the e-liquid storage element; and
a heating element comprising a heating portion, the heating portion being adapted to heat the e-liquid adsorbed in the e-liquid guiding element into a gaseous state;
wherein the electronic atomization heating battery assembly and the electronic atomization heating e-liquid storage assembly are mated with each other.

18. The electronic atomization heating device according to claim 17, wherein one of the electronic atomization heating battery assembly and the electronic atomization heating e-liquid storage assembly is provided with an engaging protrusion, a remaining one of the electronic atomization heating battery assembly and the electronic atomization heating e-liquid storage assembly is provided with an engaging recess, and the engaging protrusion is received in the engaging recess.

19. The electronic atomization heating device according to claim 17, wherein the battery management module comprises a first circuit board, the first circuit board comprises a first contact element and a second contact element;
the control module comprises a second circuit board, the second circuit board comprises a third contact element and a fourth contact element;
the connecting member comprises a first connecting member and a second connecting member, the first connecting member connects the first contact element of the first circuit board and the third contact element of the second circuit board; and the second connecting member connects the second contact element of the first circuit board and the fourth contact element of the second circuit board.

20. The electronic atomization heating device according to claim 19, wherein the first connecting member comprises a first body portion, a first bent portion bent inwardly and backwardly from one end of the first body portion, and a third bent portion bent inwardly and backwardly from another end of the first body portion; the first bent portion and the third bent portion are both parallel to the first body portion; the first body portion is secured in the battery accommodating housing;
the second connecting member comprises a second body portion, a second bent portion bent inwardly and backwardly from one end of the second body portion, and a fourth bent portion bent inwardly and backwardly from another end of the second body portion; the second bent portion and the fourth bent portion are both parallel to the second body portion; the second body portion is secured in the battery accommodating housing;
the first bent portion is in abutment with the first contact element, the third bent portion is in abutment with the third contact element, the second bent portion is in abutment with the second contact element, and the fourth bent portion is in abutment with the fourth contact element.
